(19) United States
(12) Patent Application Publication
(10) Pub. No.: US 2003/0003350 A1
(43) Pub. Date: Jan. 2, 2003

(54) Horizontal tray insert and tray assembly for motive-power applications

(75) Inventors: Drew Heimer, Lansdale, PA (US); Joseph Rozecki, Plymouth Meeting, PA (US)

Correspondence Address: HOFFMANN & BARON, LLP, 6900 JERICHO TURNPIKE, SYOSSET, NY, 11791, US

(73) Assignee: C&D Charter Holdings, Inc.

(21) Appl. No.: 10/185,328

(22) Filed: Jun. 28, 2002

Related U.S. Application Data
(60) Provisional application No. 60/302,641, filed on Jul. 2, 2001.

(51) Int. Cl. H01M 2/10; H01M 10/06

(52) U.S. Cl. 429/99; 429/97; 429/159

(57) ABSTRACT

The subject invention provides a tray assembly for use in forming a sealed lead-acid battery system which houses multiple battery cells in horizontal positions for motive-power applications. In one aspect of the subject invention, the battery system includes a plurality of sealed lead-acid battery cells, and a housing having a plurality of walls which define an interior for accommodating the battery cells. At least one tray insert bears against a base of the housing which partitions the interior into at least two compartments for accommodating the battery cells. In a second aspect of the subject invention, a sealed lead-acid battery system for motive-power applications may be provided which utilizes at least one spacer partially disposed between two battery cells to cause separation thereof.

### CROSS-REFERENCE TO RELATED APPLICATION

This application claims priority of U.S. Provisional Application No. 60/302,641, filed Jul. 2, 2001.

### BACKGROUND OF THE INVENTION

Tray assemblies are known in the prior art for maintaining multiple rechargeable battery cells (e.g., sealed vent-regulated lead-acid (VRLA) cells) in horizontal positions for motive-power applications. Motive-power applications include providing power, in rechargeable form, to Class 1 to Class 3 trucks, which include various automated guided vehicles (e.g., Class 1 and 2 trucks include electric rider trucks and electric narrow aisle trucks; Class 3 includes electric hand trucks (“pallet trucks”)). It has been found that by maintaining the battery cells in horizontal positions several benefits can be obtained including, but not limited to, maximizing acid wicking and minimizing plate stratification of cells.

For example, U.S. Pat. No. 5,441,123 to Beckley, which issued Aug. 15, 1995, discloses a cell tray configured to house six lead-acid cells. The Beckley tray includes a cell enclosure area which is divided into at least three compartments by shelf members which are rigidly attached to the side walls of the cell enclosure area.

With reference to U.S. Pat. No. 6,162,559 to Vutetakis et al., which issued Dec. 19, 2000, a tray assembly for holding battery cells in horizontal positions for motive-power applications is shown therein where battery cells are stacked one atop another, with a compression plate being located above the stack configured to apply compressive force downwardly on the entire stack to hold the cells in place. Because the compression plate needs to provide clamping force for all of the cells, the housing is not sub-divided into compartments.

Although designs are known in the prior art for trays formed to maintain battery cells in horizontal positions for motive-power applications, there is a continuous need to provide simpler and easier-to-manufacture tray designs.

### SUMMARY OF THE INVENTION

To overcome the deficiencies of the prior art, the subject invention provides a tray assembly for use in forming a sealed lead-acid battery system which houses multiple battery cells in horizontal positions for motive-power applications. In one aspect of the subject invention, the battery system includes a plurality of sealed lead-acid battery cells, and a housing having a plurality of walls which define an interior for accommodating the battery cells. At least one tray insert bears against a base of the housing which partitions the interior into at least two compartments for accommodating the battery cells.

More particularly, in a first embodiment of the first aspect of the subject invention, a box-shaped housing is provided along with at least one inverted U-shaped partition. The partition is dimensioned to slide into the housing with its downwardly depending legs bearing against the base of the housing and being in general face-to-face, or near face-to-face, contact with the side walls of the housing. When disposed within the housing, battery cells may be disposed below the cross member of the partition, as well as atop the cross member of the partition. To facilitate multiple compartments being defined within the enclosure, the partitions are formed to be stackable. As a further variation of the first embodiment, locking tabs may project from the ends of legs of the partitions, which are formed to register with corresponding locking holes located in the base of the housing and/or in a lower-stacked partition. The tabs and holes register with the partitions being fully slid into the housing.

In a second, and most preferred, embodiment, a pre-assembled partition of at least one vertical member and one horizontal member is slid into the housing to define multiple compartments therein. Whereas, with a third embodiment of the invention, tubular partitions are provided which are formed to slide into, and stack within, the housing.

In a second aspect of the subject invention, a sealed lead-acid battery system for motive-power applications may be provided which utilizes at least one spacer partially disposed between two battery cells to cause separation thereof. More particularly, in a fourth embodiment of the invention, T-shaped spacers may be provided to support edges of stacked battery cells. With this arrangement, portions of the spacers are urged between the cells and the side walls of the housing, with the main branches of the spacers being interposed between adjacent stacked cells.

With all four embodiments of the subject invention, the tray inserts (i.e., partitions) and the spacers are removable and need not be rigidly fixed to the housing. Therefore, assembly of the subject invention is relatively quick and simple as compared to the prior art. The prior art requires either rigid mounting of the tray inserts or use of a compression plate. If some rigidity is required (e.g., to minimize vibration noise), the tray insert may be fixed to portions of the housing.

These and other features of the invention will be better understood through a study of the following detailed description and accompanying drawings.

### BRIEF DESCRIPTION OF THE DRAWINGS

FIGS. 1-3 are perspective views of various tray assemblies formed in accordance with a first embodiment of the subject invention;

FIGS. 4A and 4B are perspective views of a tray assembly formed in accordance with a second embodiment of the subject invention;

FIG. 5 is a perspective view of a pre-assembled partition used in connection with the second embodiment of the subject invention;

FIG. 6 is a perspective view of a tray assembly formed in accordance with a third embodiment of the subject invention;

FIG. 7 is an elevational view of a partition used in connection with the third embodiment of the subject invention;

FIG. 8 is a perspective view of a tray assembly formed in accordance with a fourth embodiment of the subject invention;

FIG. 9 is a plan view of a spacer used in connection with the fourth embodiment of the subject invention; and

FIGS. 10-12 are perspective views of an enclosed housing used in connection with the subject invention.

### DETAILED DESCRIPTION OF THE INVENTION

The following is a description of various embodiments of the subject invention. With respect to all of the embodiments, a tray assembly for holding battery cells in horizontal positions for motive-power applications is described.

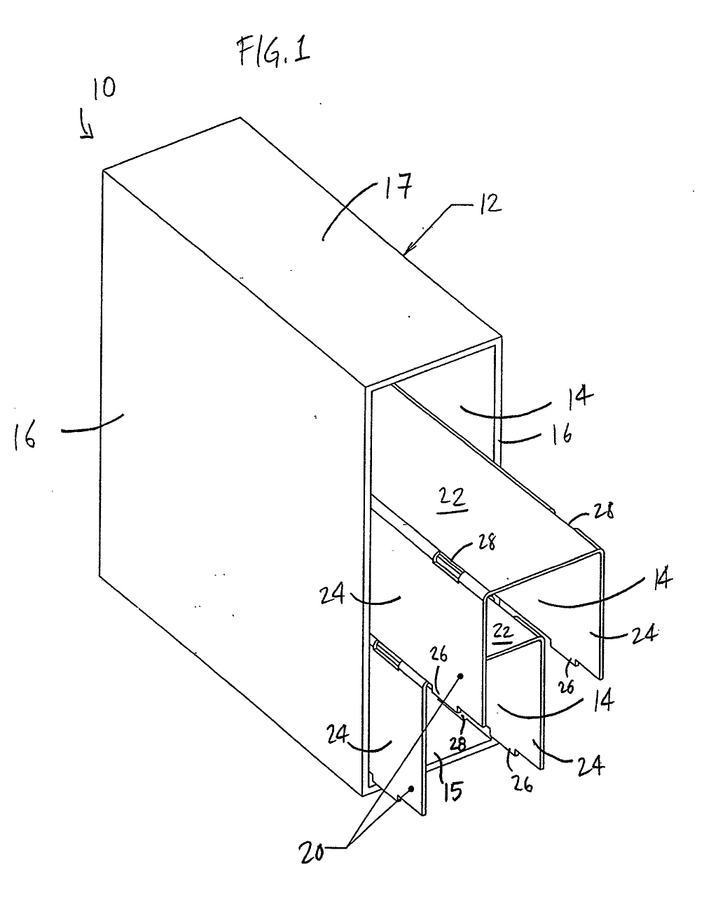

With respect to FIGS. 1-3, a first embodiment of the subject invention is shown. In particular, a tray assembly 10 is provided having a housing 12 with multiple compartments 14 defined therein for accommodating battery cells 18 in horizontal positions. The housing includes a base 15, side walls 16, and a cover 17. Partitions 20 are provided which are formed to slide into the housing 12 and partially define the compartments 14.

Each of the partitions 20 is formed with an inverted U-shape having a transverse cross member 22 with downwardly depending legs 24. The legs 24 are spaced apart approximately the same as the internal width of the housing 12 (i.e., the spacing between the side walls 16). Thus, upon sliding the partitions 20 into the housing 12, the legs 24 will be in face-to-face, or near face-to-face, contact with the side walls 16 of the housing 12. With use of multiple partitions 20, the partitions 20 are stacked vertically, with the legs 24 of an upper-stacked partition 20 being supported by the cross member 22 of a lower-stacked partition 20, whereas, the legs 24 of the lowest-stacked partition 20 will bear against the base 15. As can be readily appreciated, the specific dimensioning of the housing 12 is a direct finction of the volume of the cells 18 to be stored therein (e.g., the volume of six of the battery cells 18). Likewise, the specific dimensioning of the partitions 20 is dictated by the volume of the compartments 14 (e.g., each compartment 14 is dimensioned to accommodate two vertically-stacked battery cells 18).

Advantageously, loading applied to any of the cross members 22 will be transmitted to the base 15 via the legs 24 (and intervening partitions 20 depending on the stacked arrangement). As such, loading of upper-stacked battery cells 18 may be primarily, and directly, transmitted to the base 15. In that manner, loading of a large stack of the battery cells 18 on lower-stacked battery cells 18 may be avoided.

As a further variation, locking tabs 26 may be formed to extend from the ends of the legs 24 which are formed to register with locking holes 28 formed at the junctures of the cross members 22 and the legs 24 of the partitions 20. The locking tabs 26 are sized and located to register with the locking holes 28 when stacking one of the partitions 20 atop another. Additionally, locking holes 28 may be formed in the base 15 of the housing 12. The interengagement of the locking tabs 26 and the locking holes 28 restricts movement of the partitions 20. It is preferred that the locking tabs 26 and the locking holes 28 be in registration with the partitions 20 being fully slid into the housing 12.

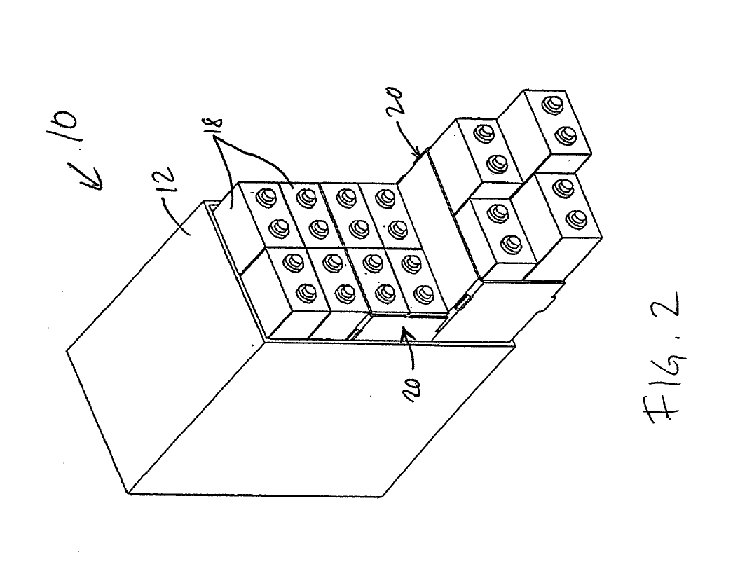

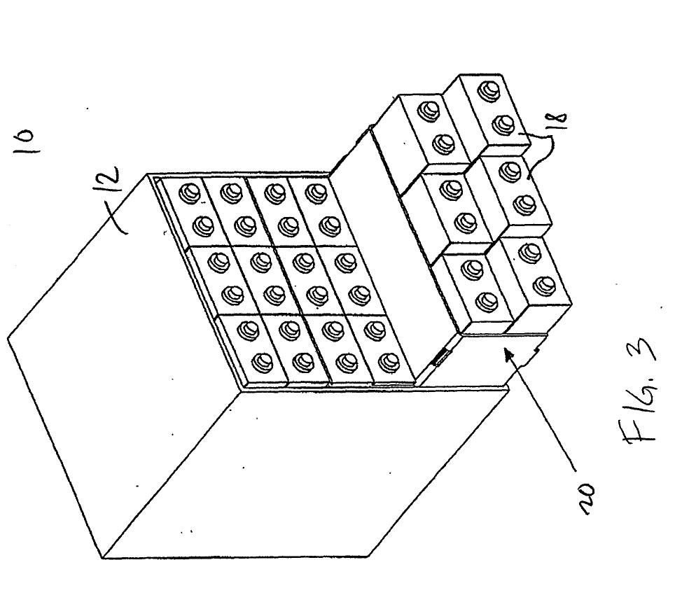

With the tray assembly 10 shown in FIG. 1, one stack of the battery cells 18 may be accommodated. As shown in FIGS. 2 and 3, the tray assembly 10 can be formed to accommodate two stacks of the battery cells 18, or three stacks of the battery cells 18. It is preferred that little free space about the battery cells 18 be provided within the tray assembly 10. Other numbers of stacks, and partitions, are possible.

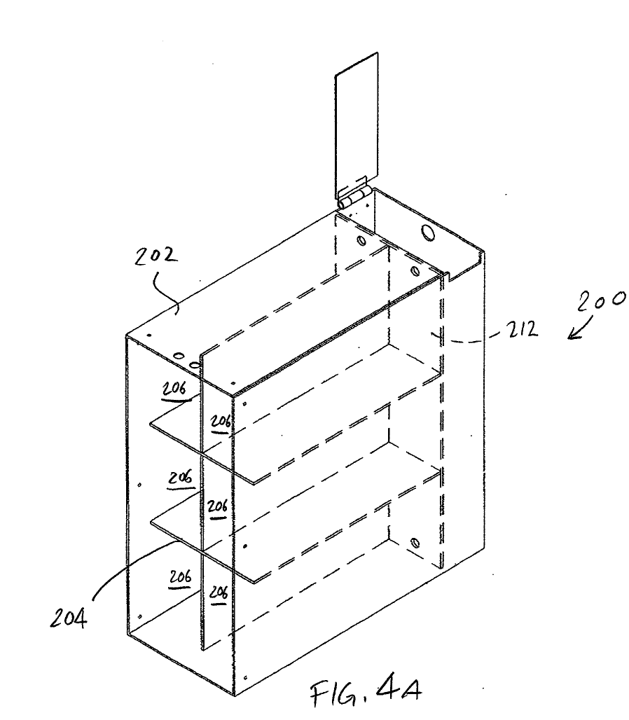

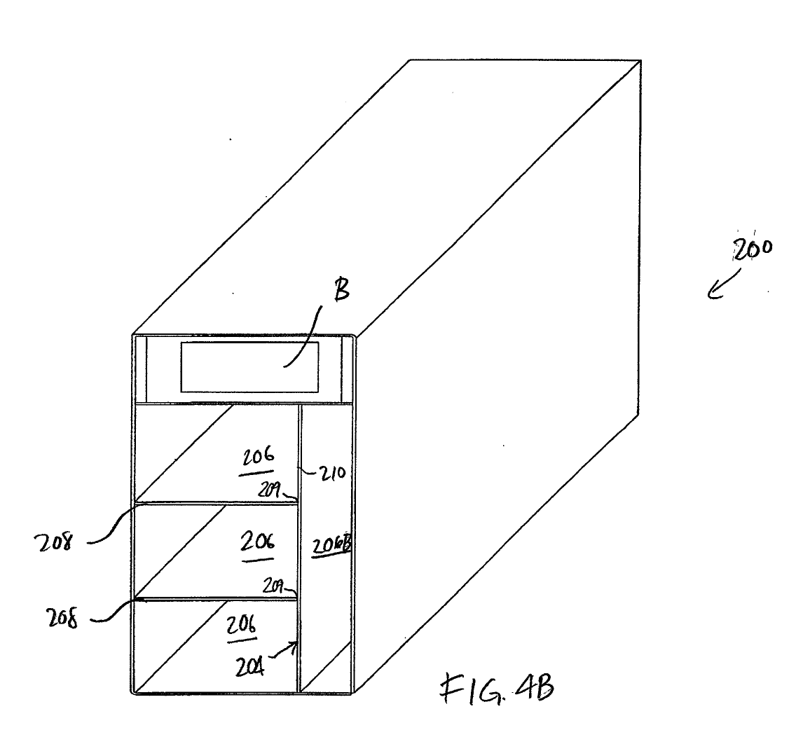

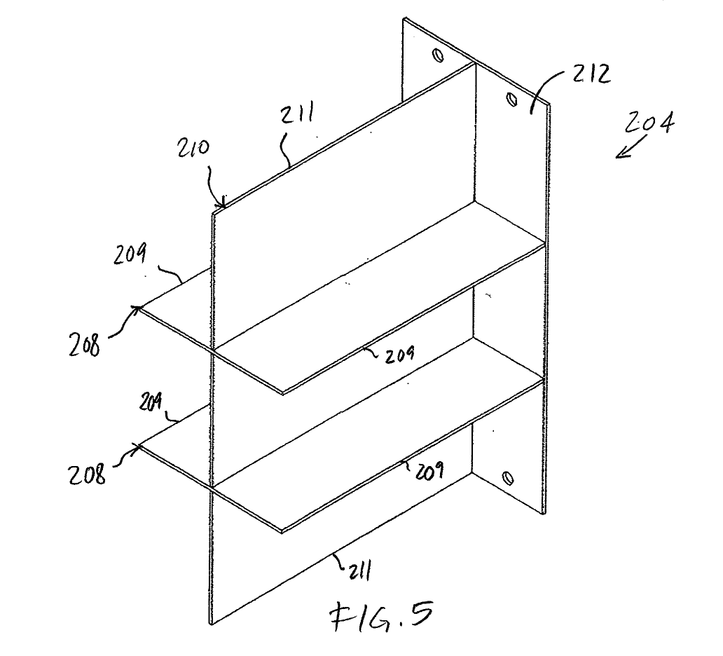

A second, and most preferred, embodiment of the invention is shown in FIGS. 4A, 4B and 5, wherein a tray assembly 200 is formed with the housing 202 having a pre-assembled partition 204 slidably disposed therein. The partition 204 divides the interior of the housing 202 into multiple compartments 206. Although not shown, each of the compartments 206 is dimensioned to receive one or more of the battery cells and/or one or more vertical stacks of the battery cells.

With reference to FIG. 5, the partition 204 is formed with at least one horizontal member 208 and one vertical member 210. In one variation, as shown in FIG. 5, the members 208 and 210 intersect at locations spaced away from respective longitudinal edges 209 and 211 of the members 208 and 210. Alternatively, as shown in FIG. 4B, the members 208 and 210 may be located to intersect at the longitudinal edge(s) 209, 211. In either respect, the vertical member 210 bears against a base of the housing 202. The members 208 and 210 are assembled together using any technique known to those skilled in the art. Once assembled, the entire partition 204 is slid into the housing 202. To provide stability to the partition 204, as shown in FIG. 4A, the edge dimensions (at the longitudinal edges 209 and 211) of the members 208 and 210 may be formed generally to the interior dimensions of the housing 202, so as to be in bearing, or in near bearing, engagement therewith without excessive play. Alternatively, as shown in FIG. 4B, the partition 204 can be formed and arranged to define one or more open compartments 206B which extend the height of the housing 202. The number and configuration of the members 208 and 210 can be varied to define the size and quantity of the compartments 206. For example, two of the horizontal members 208 may intersect the vertical member 210, or vice versa, to define six of the compartments 206; or, two of the horizontal members 208 may intersect two of the vertical members 10 to define nine of the compartments 206.

Any loading applied to the partition 204 (e.g., by stacking battery cells on portions of the horizontal member(s) 208 in one or more of the compartments 206) will be primarily transmitted to the base of the housing 202 via the vertical member(s) 210.

As a further variation, a back plate 212 may be mounted to the rear of the members 208 and 210 to provide additional stability to the partition 204. The back plate 212 may be bolted, or rigidly fixed in other manners, to the housing 202 (e.g., to a back plate of the housing 202 discussed below) for further stability and to minimize vibration noise.

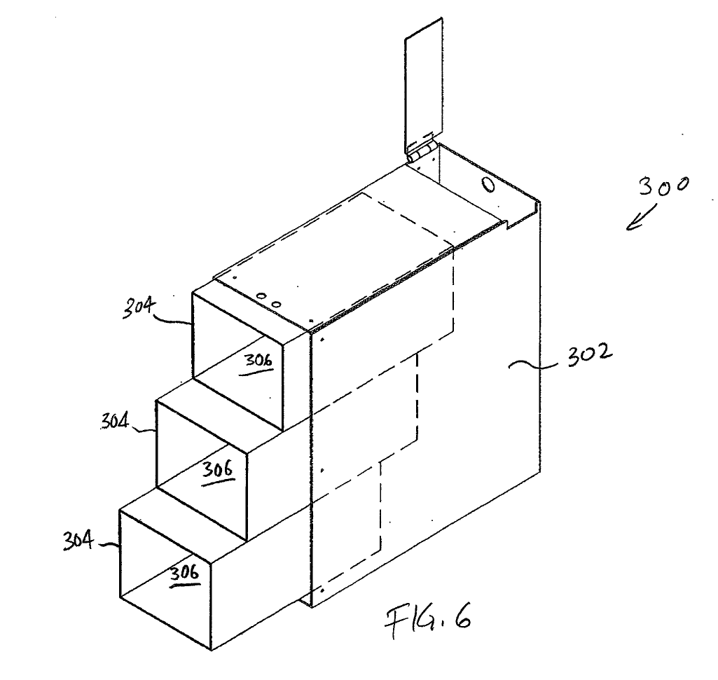

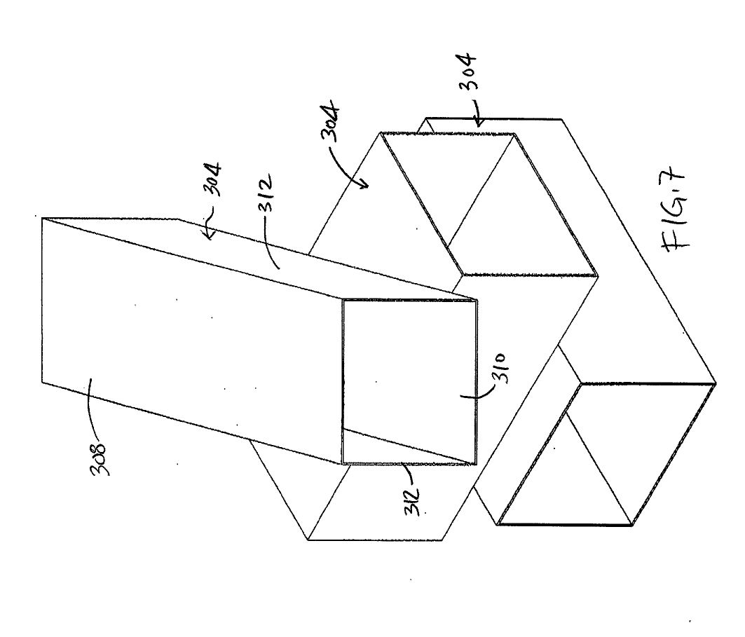

FIGS. 6 and 7 relate to a third embodiment of the subject invention wherein a tray assembly 300 is provided having a housing 302 with multiple tubular partitions 304 disposed therein. Each of the tubular partitions 304 defines a compartment 306 for receiving one or more of the battery cells and/or one or more vertical stacks of the battery cells.

As shown in FIG. 7, each of the partitions 304 is tubular so as to have an uninterrupted form which extends about the compartment 306 thereof. In a preferred embodiment, the partitions 304 have rectangular profiles with generally parallel top and bottom 308 and 310, and with a pair of generally parallel side walls 312. The partitions 304 can be formed from seamless stock or from one or more sheets bent and welded.

As with the previous embodiments, it is preferred that the side walls 312 be dimensioned to come into general face, or near face, contact with the housing 302 to be supported thereby. The dimensioning of the housing 302, as well as the partitions 304, are dictated by the number of battery cells to be accommodated and/or the number of stacks to be accommodated. The partitions 304 may be stacked with the lowest-most partition 304 bearing against a base of the housing 302 and upper-stacked partitions 304 being supported by adjacent partitions 304. Loading applied to the tops 308 of the partitions 304 (e.g., from the weight of upper-stacked battery cells) will be primarily transmitted to a base of the housing 302 through the bottoms 310 and side walls 312 (and any intervening partitions 304).

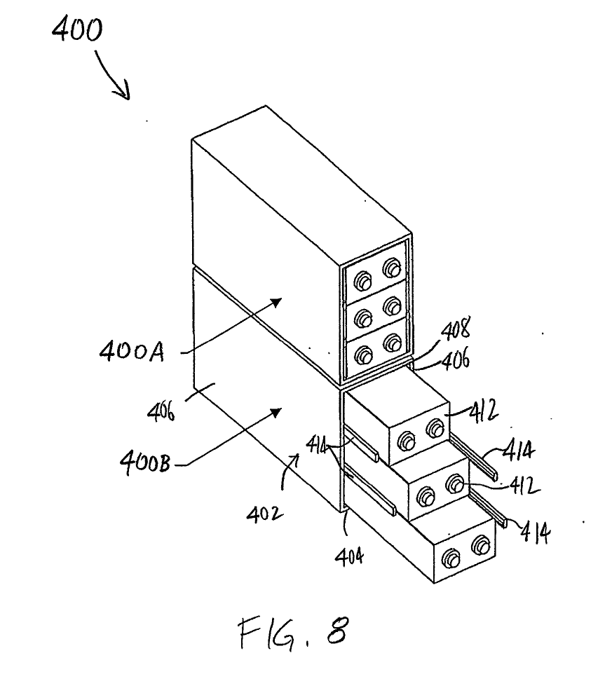

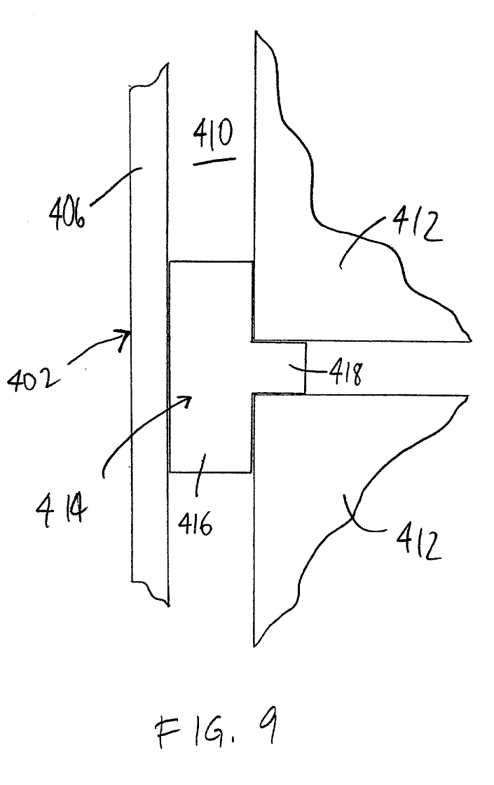

With reference to FIGS. 8 and 9, a fourth embodiment of the subject invention is shown wherein a tray assembly 400 is provided. The tray assembly 400 can be formed as a single, stand-alone unit, or formed from smaller stacked tray assemblies 400A and 400B. For illustrative purposes, reference will be made to the tray assembly 400B. It is to be understood that the tray assembly 400A is similarly structured.

The tray assembly 400B includes a housing 402 having a base 404, side walls 406, and a cover 408 formed to define a single compartment 410. The compartment 410 is not partitioned into smaller compartments as with the other embodiments of the subject invention. Rather, battery cells 412 are held in a spaced apart relationship within the compartment 410 by elongated spacers 414.

As best shown in FIG. 9, each of the spacers 414 is cross-sectionally formed with a T-shape, having a cross piece 416 formed to define a space between the battery cells 412 and side walls 406 of the housing 402, and a main branch 418 formed to be interposed between stacked battery cells 412 to define spaces therebetween. Preferably, two of the spacers 414 are spaced-apart and inwardly directed to cooperatively separate a pair of the battery cells 412. It is preferred that the housing 402 be formed to tightly accommodate a stack of the battery cells 412 being spaced apart by the spacers 414.

The edge support provided by the spacers 414 is advantageously provided to the side walls of the battery cells 412 which are the strongest portions of the jars of the battery cells 412. With the weight of the battery cells 412 being concentrated on the side walls of the jars, direct pressure on the plates of the battery cells 412 is minimized or altogether eliminated. Nevertheless, it can be appreciated that since the battery cells 412 are not fully supported by partitions, but rather have edge support from the spacers 414, the height of the stack is preferably limited because of the limited edge support. It is desirable to avoid excessively high loading on the battery cells due to an excessive number of cells being stacked. Unlike the previous embodiments, no tray insert is provided in this embodiment which directly transmits load to the base of the housing from upper stacked cells. It is therefore preferred that, as described above, the stack be separated between the two tray assemblies 400A and 400B and other tray assemblies, as required. As an alternative, if loading is not a concern, a single tray assembly can be utilized.

With respect to all of the embodiments discussed above, the tray inserts (partitions 20, 204, 304) and the spacers 414 are slidably disposed within the associated housing, and not necessarily rigidly fixed thereto. Advantageously, the slidable mounting not only eases manufacturing of the tray assemblies, but also permits easy removal of battery cells and re-configuration of the tray assemblies, if desired, so as to accommodate different size and/or number of battery cells. If some rigidity is required (e.g., to minimize vibration noise), the tray inserts may be fixed to portions of the housing.

The tray inserts, spacers, and housings are also formed of any suitable material (e.g., metal) which is acceptable for use in motive-power applications, particularly to satisfy explosion-proof and spark-proof requirements such as those set forth by the Underwriters Laboratories (UL-583).

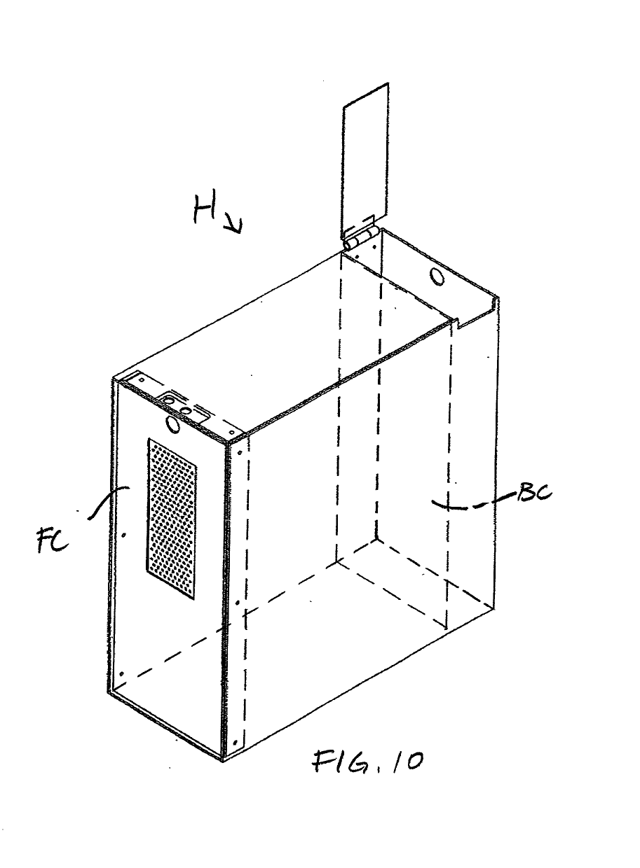

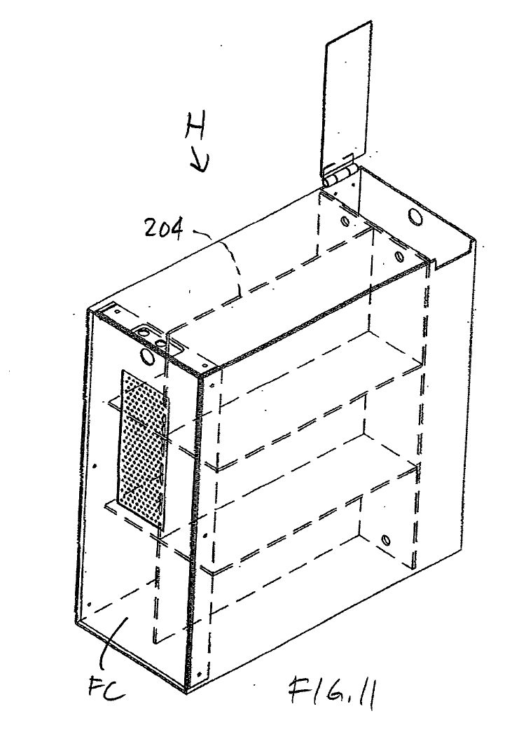

With further reference to all of the embodiments discussed above, a front cover FC may be mounted to housing H (housing H is equivalent to the housings 12, 202, 302 and 402) as shown in FIG. 10. In addition, a back cover BC may be provided so that the housing H can include a full enclosure with an opening for receiving the battery cells—that opening being covered by the front cover FC. With reference to FIG. 11, a tray insert (e.g., tray insert 204) is mounted into the housing H behind the front cover FC. Open compartments (such as open compartment 206B) may be defined in the housing H by any of the tray inserts such as by leaving a space or spaces between the tray insert and the side wall of the housing H. With any of the compartments (open or otherwise), battery cells can be stacked vertically and/or horizontally (preferably, horizontally).

A battery charger B may also be disposed within the housing H or attached thereto. Preferably, the battery charger B is mounted via panel opening PO into an additional enclosed space located behind the back cover BC of the housing H. With panel P closing the panel opening PO, the battery charger B is filly enclosed. In addition, apertures may be formed in the housing H so as to give access to the battery cells (e.g., apertures A in the front cover FC to give access to the battery terminals). The battery charger B may be mounted into an enclosed space above the tray insert and battery cells (as shown in FIG. 4B). The battery cells may be connected in series or in parallel and cables are electrically connected to the battery cells suitable for connecting to a motive device requiring power.

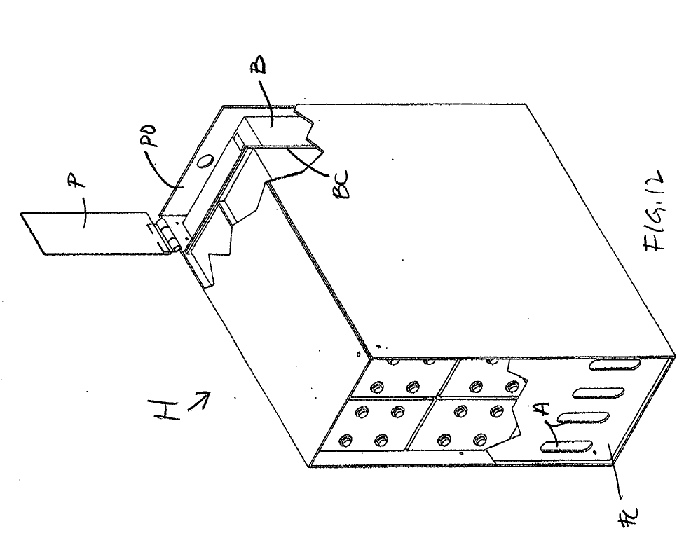

The entire housing H is mountable to a motive-powered vehicle to supply power thereto. With reference to U.S. Pat. No. 5,441,123, particularly FIGS. 11-13 and the associated description thereof, the housing H is mountable to Class 1-3 vehicles. The entire disclosure of U.S. Pat. No. 5,441,123 is incorporated by reference herein.

Various changes and modifications can be made to the present invention. It is intended that all such changes and modifications come within the scope of the invention as set forth in the following claims.

What is claimed is:

1. A sealed lead-acid battery system for motive-power applications, said system comprising:
a plurality of sealed lead-acid battery cells;
a housing having a base, a cover and at least two upstanding side walls extending between, and connecting, said cover and said base, wherein said cover, said base and said side walls at least partially define an interior for accommodating said battery cells; and,
at least one tray insert bearing against said base panel, said tray insert partitioning said interior into at least two compartments.

2. A battery system as in claim 1, wherein loading applied to said tray insert is transmitted primarily to said base.

3. A battery system as in claim 1, wherein said tray insert has an inverted U-shape with a transverse cross member and two downwardly depending legs.

4. A battery system as in claim 3, wherein said legs bear against said base.

5. A battery system as in claim 3, wherein said legs are in face-to-face or near face-to-face contact with said side walls of said housing.

6. A battery system as in claim 3, wherein at least one locking tab extends from said legs formed to register with a locking hole defined in said base.

7. A battery system as in claim 3, wherein a second tray insert is stacked on said first-mentioned tray insert, said second tray insert having an inverted U-shape with a transverse cross member and two downwardly depending legs, said legs of said second tray insert bearing against said first-mentioned tray insert.

8. A battery system as in claim 7, wherein at least one locking tab extends from said legs of said second tray insert formed to register with a locking hole defined in said first-mentioned tray insert.

9. A battery system as in claim 1, wherein said tray insert includes at least one horizontal member and at least one vertical member which intersect.

10. A battery system as in claim 9, wherein said tray insert further includes a back plate disposed transversely to, and connected to, said horizontal and vertical members.

11. A battery system as in claim 1, wherein said tray insert is tubular.

12. A battery system as in claim 11, wherein said tray insert has a rectangular profile.

13. A sealed lead-acid battery system for motive-power applications, said system comprising:
a plurality of sealed lead-acid battery cells;
a housing having a base, a cover and at least two upstanding side walls extending between, and connecting, said cover and said base, wherein said cover, said base and said side walls at least partially define an interior for accommodating said battery cells; and,
at least one spacer partially disposed between two of said battery cells to separate the cells.

14. A battery system as in claim 13, wherein said spacer is cross-sectionally formed with a T-shape having a crosspiece disposed between said battery cells and one of said side walls of said housing, and a main branch extending from said crosspiece interposed between said battery cells.

15. A battery system as in claim 13, wherein two of said spacers are disposed in a spaced-apart relation partially between two of said battery cells to cause separation thereof.
